(19) United States
(12) Patent Application Publication
(10) Pub. No.: US 2023/0101073 A1
(43) Pub. Date: Mar. 30, 2023

(54) Housing for Accommodating a Battery Module

(71) Applicant: HBPO GmbH, Lippstadt (DE)

(72) Inventor: Reinhold Brückner, Herzebrock-Clarholz (DE)

(21) Appl. No.: 17/799,531

(22) PCT Filed: Jan. 18, 2021
(86) PCT No.: PCT/EP2021/050953

§ 371 Date: Aug. 12, 2022

(30) Foreign Application Priority Data
Feb. 13, 2020 (DE) 10 2020 103 793.7

(51) Int. Cl. H01M 10/6556; H01M 50/224; H01M 10/613

(52) U.S. Cl. CPC H01M 10/6556; H01M 50/224; H01M 10/613; H01M 2220/20; H01M 10/625

(57) ABSTRACT

The invention relates to a housing (2) for receiving a battery module (1), comprising a front housing part (4), a rear housing part (6), a first and second central housing part (8a, 8b) arranged between the front housing part (4) and the rear housing part (6), wherein the front housing part (4), the rear housing part (6) and the two central housing parts (8a, 8b), when the housing parts (4, 6, 8a, 8b) are connected to one another, ensuring that the battery module (1) is fully accommodated, and an integrated cooling channel (10) for cooling the battery module (1) being arranged inside the housing (2).

The present invention relates to a housing for accommodating a battery module, a battery system, and a method for receiving a battery module.

Devices for accommodating battery modules are known from the prior art and are used primarily in automotive engineering. However, the disadvantages of the known devices—especially when used in a motor vehicle—are the large installation space that is generally required and the high weight that the devices in question entail. Smaller and lighter systems are also known, but these systems are generally not particularly stable and can therefore only be used to a very limited extent, for example not in motor vehicles. Another disadvantage of the known devices and systems for holding battery modules is that they are often insufficiently adaptable to the frequently individual geometries of the battery modules to be held, resulting in slow and cost-intensive production.

It is therefore the object of the present invention to at least partially eliminate the above-mentioned disadvantages of known housings and devices for accommodating battery modules. In particular, it is the task of the invention to provide a housing for accommodating a battery module which permits a stable and at the same time compact arrangement of a battery module and can be manufactured simply and inexpensively.

The foregoing object is solved by a device having the features of the independent device claim, a system having the features of the independent system claim, and a method having the features of the independent method claim. Further features and details of the invention are apparent from the dependent claims, the description and the drawings. Technical features disclosed with respect to the apparatus according to the invention also apply in connection with the system according to the invention as well as the method according to the invention and vice versa in each case, so that with respect to the disclosure of the individual aspects of the invention reference is or can always be made mutually. Useful embodiments of the invention are set forth in the dependent claims.

According to the invention, a housing for accommodating a battery module is provided, which comprises a front housing part, a rear housing part, and a first and a second central housing part arranged between the front housing part and the rear housing part, wherein the front housing part, the rear housing part and the two central housing parts, in the connected state of the housing parts to one another, ensure a fully comprehensive accommodation for the battery module, and wherein an integrated cooling channel for cooling the battery module is arranged within the housing.

The present housing for accommodating a battery module can be provided in particular for use in a motor vehicle and can be arranged in the underbody, in the engine compartment or, for example, in the trunk of the motor vehicle. In addition to use in passenger cars and trucks, the housing according to the invention can also be used in other motorized vehicles, such as ships or flying objects or the like. The housing can accommodate battery modules at various voltage levels, for example at 12 V, 24 V, 48 V or 800 V levels or the like.

The housing parts in question are designed/configured in particular in the form of separable, independent housing parts or components which are preferably manufactured in an independent manufacturing process and can then be assembled to form a housing in question. The composition of the front housing part, the rear housing part and the two central housing parts to form the housing according to the invention allows to fully accommodate or enclose a battery module. In the context of the invention, an integrated cooling channel is preferably understood to mean a cooling channel which can be filled with a coolant such as water and which can be arranged at least partially in one or more of the present housing parts. It is understood that the present cooling channel can also be filled or operated with other coolants. When used in a motor vehicle, the cooling channel may further be connected to the cooling circuit of the vehicle in question. In the context of the invention, a battery module may in particular comprise a cell module with battery cells as well as a converter, for example a DC/DC converter or the like.

Within the scope of the invention, it has been recognized that a versatile and flexibly adaptable accommodation unit for battery modules can be made available by means of a front, a rear and two central housing parts, which, in particular due to its versatility and adaptability, can be manufactured, replaced and maintained quickly and easily at the same time. Furthermore, the integration of a cooling channel according to the invention creates in particular a compact and space-saving mounting unit for accommodating a battery module.

Within the scope of a particularly lightweight and material-saving design/configuration of the present housing, it can be provided in accordance with the invention in particular that the housing has an at least partially profiled structure, wherein in particular the first and/or the second central housing part has a profiled structure. Preferably, the profiled structure is designed/configured in the form of double-wall profiles, whereby both the wall thicknesses and the cross-sectional areas and/or shapes of the recesses of the profiled structure can be variable.

In the context of a lightweight, material-saving and at the same time stable design/configuration, it can also be provided that the profiled structure is at least partially filled with a shock-absorbing material, the shock-absorbing material preferably being formed in the form of a foam. A filling with shock-absorbing materials can be provided here in particular for lateral sections of the first and second central housing parts, in order thereby to ensure lateral impact protection for a battery module, for example when the housing is used in a motor vehicle.

Regarding to simple, fast and inexpensive production, in particular of larger numbers of the housings in question, it can also be provided in accordance with the invention that the housing is at least partially formed in the form of extruded profiles, in particular the first and/or the second central housing part being formed in the form of extruded profiles.

In order to ensure a high degree of stability at the same time, the housing can also be partially formed in the form of a metal material, preferably at least partially in the form of an aluminum material.

With regard to a simple and fast reception, a simple and fast exchange and a simple and fast maintenance of a battery module, it can be further provided that parts of the housing, preferably at least the first and the second central housing part, are materially bonded to each other.

In order to ensure a particularly fast assembly of a present housing, the first and the second central housing part may further be formed in an L-shape, wherein preferably the first central housing part comprises a side plate and a bottom plate arranged substantially perpendicular to the side plate, and the second central housing part comprises a side plate and a top plate arranged substantially perpendicular to the side plate. For example, the first central housing portion may be formed in the form of a lid (with side panel), whereas the second central housing portion may be formed in the form of a corresponding base (with side panel). Advantageously, the first and second central housing parts have essentially the same surface area, whereby in particular the respective side plates or the bottom and top plates correspond in terms of their surface area.

In order to provide the safest possible accommodation of a battery module within the present housing, it is also conceivable that the first and/or the second central housing part has a fixing rail for material-bonding of a battery module, the fixing rail preferably being arranged on the side panel of the first and/or the second central housing part, in particular in a base area of the side panel of the first and/or the second central housing part. The arrangement in a bottom area makes it possible, in particular, to fix the mostly heavy battery modules, comprising cell modules and converters, in a particularly simple manner by simply sliding the battery modules into the fixing rail or rails. To eliminate Z-tolerances, it is also possible to provide for the fixing rail to be slightly beveled, preferably to correspond in shape to the corresponding counterpart of the battery module.

Within the scope of a simple connection of the present first and second central housing units—which likewise permits simple maintenance and simple replacement of battery modules—it can be further provided according to the invention that the first and second central housing parts have a first and second fastening profile for form-fitting fastening of the central housing parts to one another, the fastening profiles preferably being arranged along the longitudinal sides of the first and second central housing parts and in particular being designed/configured to correspond in shape to one another.

Advantageously, the fastening profiles are formed in the form of recesses and protrusions, preferably in the form of recesses and protrusions corresponding in shape to one another, in particular in the form of at least part-circular recesses and protrusions. Via the arrangement of at least a part-circular first and second fastening profile, it is in particular possible to mount the first and second central housing parts rotatably relative to one another, so that the first central housing part can, for example, engage in a part-circular recessed profile of the second central housing part via a part-circular recessed fastening profile and can be rotated into the correct position within the part-circular recessed profile for fastening to the opposite side. On the opposite side, the fastening profiles may also be formed in the form of other types of corresponding recesses and protrusions, for example a rib and a corresponding receptacle, so that the first and second central housing parts can be fixed together along two axes.

In order to improve the material-bonding, it can also be provided that at least one of the fastening profiles has an undercut and at least one of the fastening profiles has a corresponding latching hook to reinforce the material-bond.

For simple, in particular reversible, fixing of the front and rear housing parts, it can also be provided in accordance with the invention that the first and second central housing parts have a plurality of recesses for receiving fixing elements, the recesses preferably being arranged on the head side within the first and second central housing parts, in particular in the corner areas of the first and second central housing parts. The fixing elements can here preferably be formed in the form of screws, bolts or rivets or the like. To ensure the most uniform fixing possible, at least four, in particular at least six, fixing elements are preferably provided here, which can preferably be distributed as uniformly as possible over the head-side area of the first and second central housing part.

Within the scope of a particularly effective dissipation of heat from a battery module, it can also be provided according to the invention that the cooling channel integrated within the housing is arranged within the first and/or the second central housing part, preferably in the base plate of the first central housing part. Likewise, it is possible that the channel is also arranged within the side plates and/or the cover plate.

For the most effective cooling process possible, according to the invention, it can further be provided that the cooling channel has at least one flow for introducing cooling water and a return for returning the cooling water.

In order to ensure the most individual possible design/configuration of a channel with regard to geometry, course, diameter or coolant pressure, it can also be provided in accordance with the invention that the cooling channel integrated within the housing has at least two cooling paths arranged next to one another and separated from one another, the cooling paths being separated from one another by means of a strut. The cooling paths can be of essentially the same size or of different sizes. The strut provided serves in particular to ensure a minimum degree of rigidity of the cooling channel.

With a view to maximizing a cooling effect, it is also conceivable that the cooling channel has cooling fins, the cooling fins preferably being arranged on the upper side, in particular adjacent to the bottom surface of the housing. It is understood that the number of cooling channels, their geometry and size can be varied as desired and can preferably be adapted to the type of battery module to be accommodated, in particular to the cooling power to be provided. For example, the number and design/configuration of the cooling fins can also be adapted with regard to the battery module. One object here can be to achieve the most powerful and uniform cooling possible.

For the purpose of preventing water from entering the housing, it may be further provided that seals are provided for sealing the housing from the outside, the seals preferably being formed in the form of sealing cords which are arranged in particular along the boundary surfaces between the first and second central housing parts.

With regard to the most effective sealing possible, the seals can be formed in the form of a rubber-based material or a polyurethane-based material or an epoxy-based material. Preferably, nitrile rubbers, perfluor-rubbers, chlorosulfonyl polyethylene rubbers, SL-PU, LT-PU or also Teflon, ethylene-propylene terpolymer or fluoroelastomer can be used here.

With regard to a preferably multifunctional design/configuration of the present housing, it can be advantageously provided according to the invention that the front housing part is formed in the form of a multi-part component, wherein the front housing part preferably comprises more than three, in particular more than four, assembled separable elements.

In order to prevent water from entering the housing, for example, the front housing part can be provided with at least one sealing element for sealing the housing, the sealing element preferably being arranged on the end face of the first and second central housing parts, in particular being connected to the first and second central housing parts by a material-bond. A material-bonding connection between the first and second central housing parts and the sealing element can advantageously be produced in this case by means of a 2K injection molding process. Alternatively, the sealing element can also be bonded or welded to the first and second central housing parts. It is also conceivable that the sealing element is frictionally connected to the first and second central housing parts via fixing elements or materially bonded, for example via latching lugs and corresponding undercuts. For easy establishment of a force-locking connection, the sealing element can further comprise recesses for the introduction of fixing means/elements. It is also advantageous if the sealing element has recesses for connection to the cooling channel.

To increase the stability of the housing, it can advantageously also be provided that the front housing part has at least one reinforcing plate for reinforcing the front housing part, the reinforcing plate preferably being arranged on the end face of the sealing element, the reinforcing plate being formed in particular from a metal material, especially preferably from an aluminum material. The reinforcing plate can be bonded to the sealing element in a form-fitting, preferably force-fitting, in particular material-bonding manner and, like the sealing element, can have recesses for receiving fixing elements and for connection to the cooling channel.

Furthermore, it is conceivable that the front housing part has at least one cover element for covering the front housing part, the cover element preferably being arranged on the end face of the reinforcing plate, the cover element being formed in particular from a plastic, especially preferably from polyethylene. In this case, the cover element can be connected to the reinforcing sheet in a form-fitting, preferably force-fitting, in particular material-bonding manner. Alternatively, it is also possible for the cover element to be manufactured together with the reinforcing sheet in a hybrid design/configuration.

Within the scope of a structurally simple introduction of a cooling channel, it can be further provided in an advantageous manner according to the invention that the front housing part has a first and a second connection for connection to a forward flow and a return flow of a cooling channel, the connections preferably being connected to the cover element by a form-fitting fastening, in particular being formed integrally with the cover element.

Within the scope of a structurally simple introduction of a cooling channel, it is also conceivable that the connections each have an inlet connection piece for connection to a coolant supply line and each have a connection piece for connection of the inlet connection piece to the flow and the return of the cooling channel, the connections preferably being formed from a plastic, in particular from polyethylene. It is also possible to provide that only parts of the connections, for example the connection pieces, are formed in one piece with the cover element and that the inlet connections are welded or glued as individual components, for example subsequently, to the cover element or the connection pieces.

With regard to a preferably multifunctional design/configuration of the present housing, it can be further provided in an advantageous manner according to the invention that the rear housing part is also formed in the form of a multi-part component, the rear housing part preferably comprising more than two, in particular more than three, assembled separable elements.

In order to prevent water from entering the housing, for example, the rear housing part can be provided with at least one sealing element for sealing the housing, the sealing element preferably being arranged on the end face of the first and second central housing parts, in particular being connected to the first and second central housing parts by a form-fitting fastening. A material-bonding connection between the first and second central housing parts and the sealing element can advantageously be produced in this case by means of a 2K injection molding process. Alternatively, the sealing element can also be bonded or welded to the first and second central housing parts. It is also conceivable that the sealing element is frictionally connected to the first and second central housing parts via fixing elements or positively, for example via latching lugs and corresponding undercuts. For easy creation of a force-fit connection, the sealing element can further comprise recesses for the introduction of fixing elements. To increase the stability of the housing, it can advantageously further be provided that the rear housing part has at least one reinforcing plate for reinforcing the rear housing part, the reinforcing plate preferably being arranged on the end face of the sealing element, the reinforcing plate being formed in particular from a metal material, particularly preferably from an aluminum material. The reinforcing plate can be connected to the sealing element in a form-fitting, preferably force-fitting, in particular material-bonding manner and, like the sealing element, can comprise recesses for receiving fixing elements and a recess for carrying out emergency degassing.

Furthermore, it is conceivable that the rear housing part has at least one cover element for covering the front housing part, the cover element preferably being arranged on the end face of the reinforcing plate, the cover element being formed in particular from a plastic, especially preferably from polyethylene. In this case, the cover element can be connected to the reinforcing sheet in a form-fitting, preferably force-fitting, in particular material-bonding manner. Alternatively, it is also possible for the cover element to be manufactured together with the reinforcing plate and/or the sealing element in a hybrid design/configuration.

Within the scope of a structurally simple guidance of a channel within a housing, it can be further provided according to the invention that the cover element comprises a transfer structure for transferring the forward flow of the coolant channel into the return flow, wherein the transfer structure preferably has an arcuate shape.

Within the scope of the safest possible design/configuration of the housing according to the invention for accommodating a battery module, it can also be provided in an objectively advantageous manner that the rear housing part has at least one degassing connection piece for emergency degassing, the degassing connection piece preferably being connected to the cover element by a form-fitting fastening, in particular being formed integrally with the cover element. The degassing connection piece is provided here for discharging battery gases and is intended to prevent a fire or, in the event of a fire, to prevent an explosion. The degassing connection piece can also be formed from a plastic, preferably polyethylene.

Within the scope of a structurally simple design/configuration of the integration of a cooling channel within a housing, in particular a structurally simple design/configuration of the integration of a transfer structure for transferring the forward flow of the cooling channel into the return flow, it can be provided in an objectively advantageous manner that the rear housing part has a closure element for closing the transfer structure of the cover element, the closure element being formed from a plastic, preferably from polyethylene.

It is also an object of the invention to provide a battery system. Here, the battery system comprises a housing described above for accommodating a battery module, and a battery module comprising a cell module and a DC/DC-converter. Thus, the battery system according to the invention provides the same advantages as have already been described in detail with respect to the housing according to the invention.

In the context of an automatic or automatable operation of a cooling system or a degassing system for a battery module, it can be advantageously provided according to the invention that a detection unit is provided for the acquisition of data for the operation of a cooling system. In this context, the detection unit can preferably comprise sensors for determining a current temperature or a current pressure or a current pollutant concentration or the like. In addition to a detection unit, a processing unit may further be provided for determining a change parameter, such as the current coolant pressure or the current coolant temperature or the like, based on the detected data. Further, a control unit may be provided for controlling a pump or cryostat or the like to implement the determined change parameter.

Also an object of the invention is a method for receiving a battery module in a housing, in particular in a housing described above. Here, the method comprises the steps/stages of receiving the battery module via a first central housing part, covering the received battery module by materially bonding the first central housing part to a second central housing part, and closing the housing by connecting the first and second central housing parts to a front housing part and a rear housing part. Thus, the method according to the invention provides the same advantages as have already been described in detail with respect to the housing according to the invention or the battery system according to the invention.

In order to create the safest possible accommodation of a battery module within the present housing, it is further conceivable that the battery module is inserted into a fixing rail during accommodation in the first central housing part for form-fitting fastening of the battery module.

Within the scope of a simple connection of the present first and second central housing units—which also permits simple maintenance and simple replacement of battery motors—it can also be provided according to the invention that the second central housing part is inserted into a corresponding first fastening profile of the first central housing part via a first fastening profile for materially bonded connection to the first central housing part and is inserted into a corresponding second fastening profile of the first central housing part by a rotation with a second fastening profile. The materially bonded connection can be further strengthened in this case by the second fastening profiles of the first and second central housing parts being formed in the form of latching hooks and corresponding undercuts.

Further advantages, features and details of the invention will be apparent from the following description, in which embodiments of the invention are described in detail with reference to the drawings. In this connection, the features mentioned in the claims and in the description may each be essential to the invention individually or in any combination.

It shows:

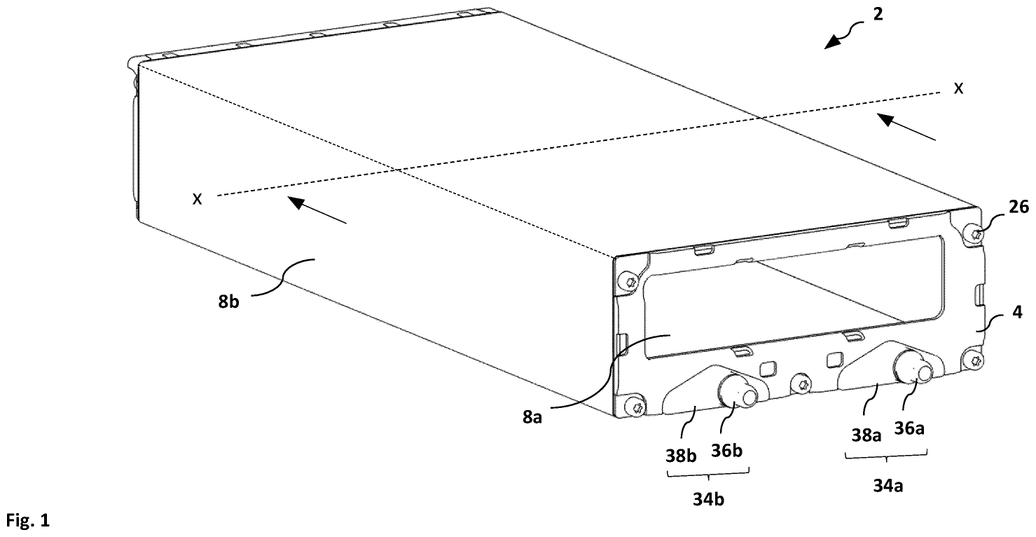

FIG. 1 a schematic representation of a housing according to the invention for accommodating a battery module in a spatial view from the front according to a first embodiment,

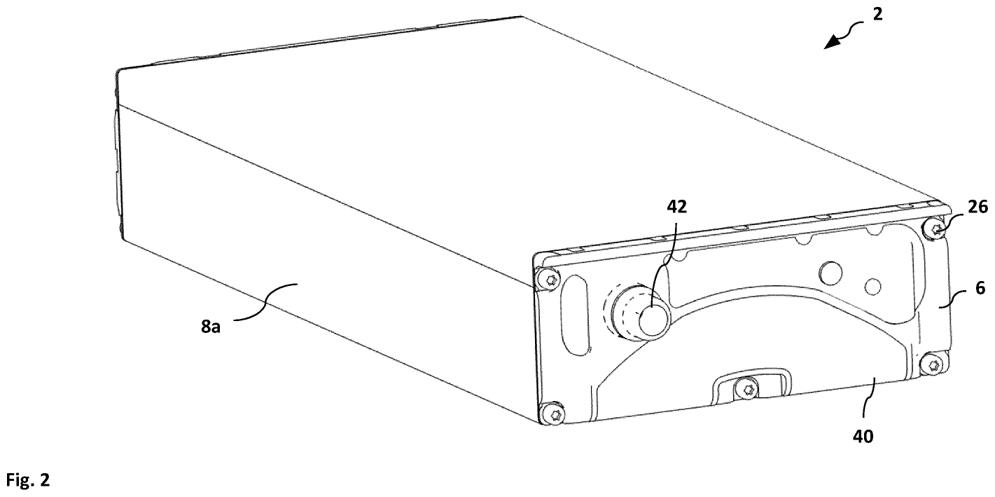

FIG. 2 a schematic representation of a housing according to the invention for accommodating a battery module in a spatial view from the rear according to a first embodiment,

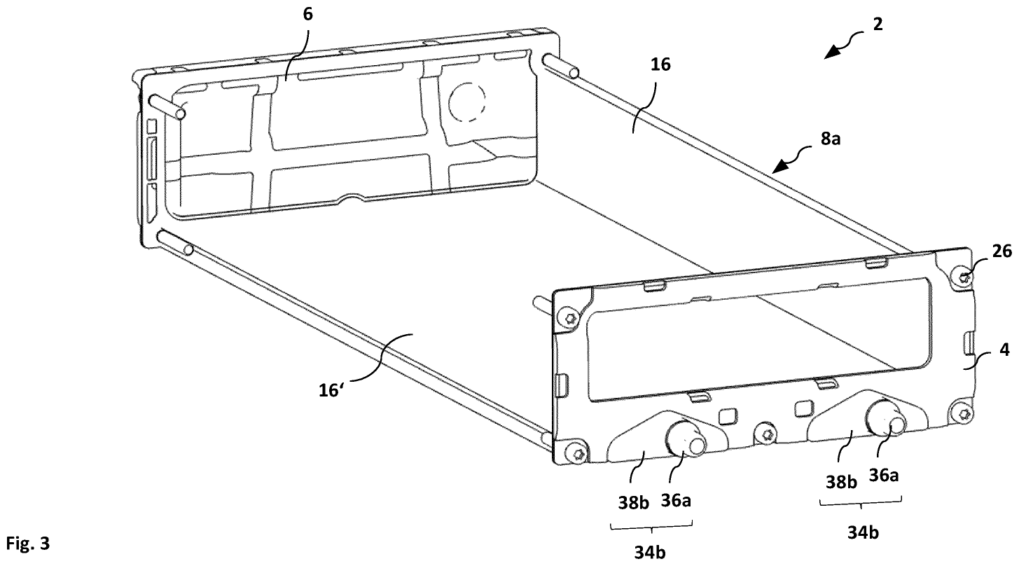

FIG. 3 a schematic representation of the housing according to the invention as shown in FIG. 1 without the second central housing part,

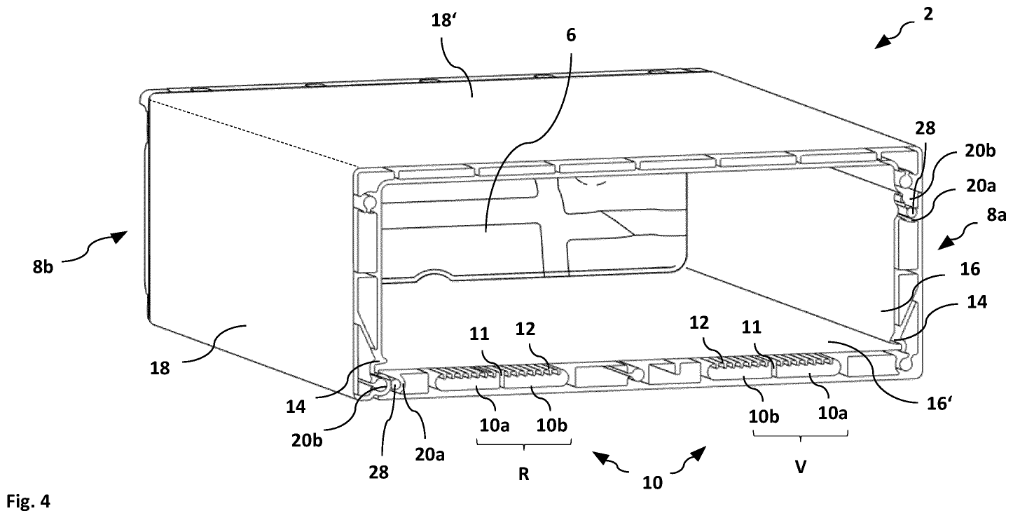

FIG. 4 a schematic representation of a housing according to the invention for accommodating a battery module in a sectional view along the line of intersection X-X from FIG. 1 according to a first embodiment,

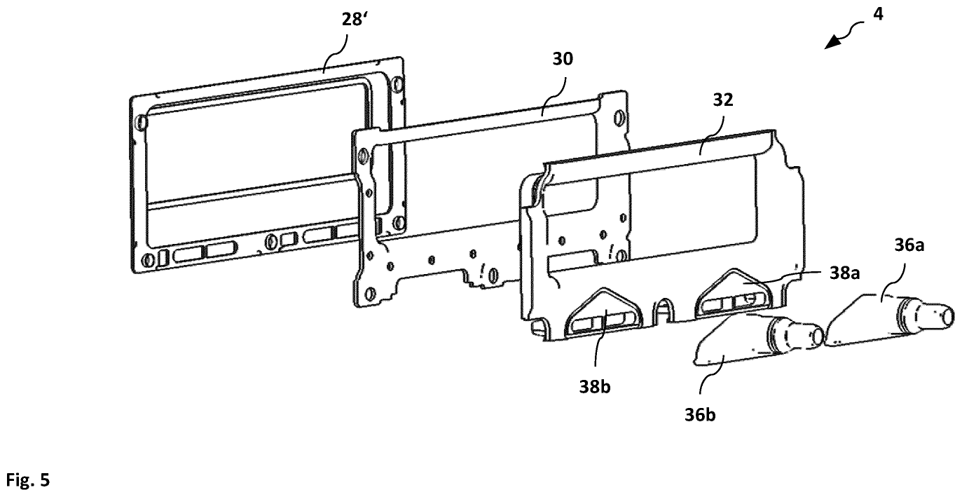

FIG. 5 a schematic representation of the front housing part according to the invention in an exploded view according to a first embodiment,

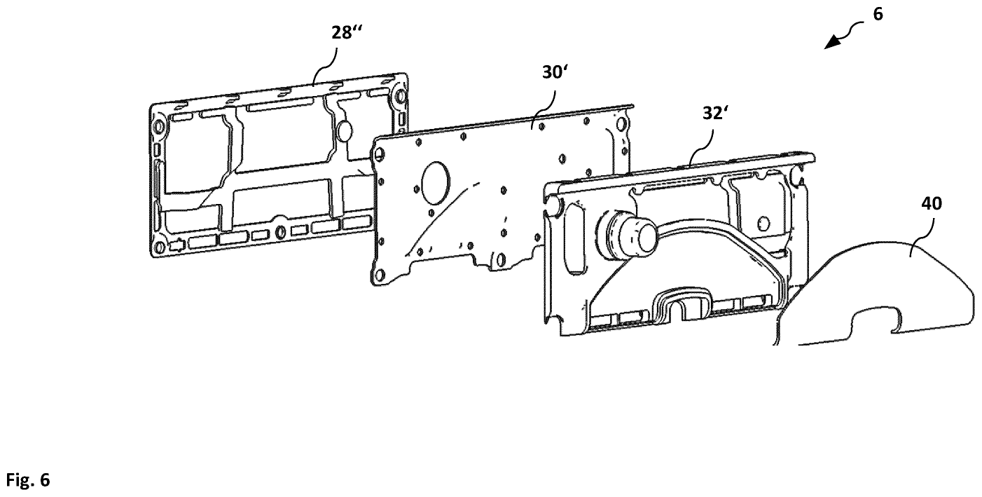

FIG. 6 a schematic representation of the rear housing part according to the invention in an exploded view according to a first embodiment,

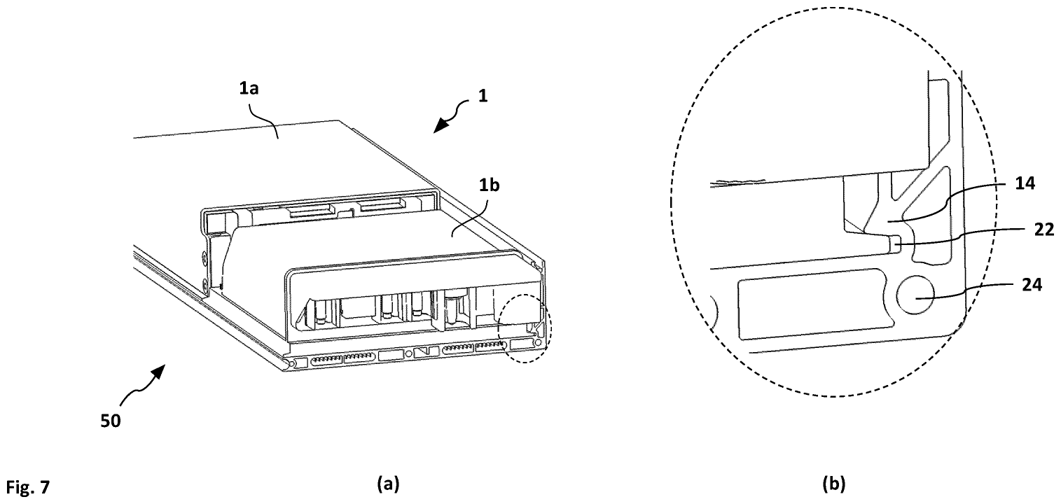

FIG. 7a, b a schematic representation of a partial section of a battery system according to the invention in a spatial representation (a) and an enlarged view (b) according to a first embodiment,

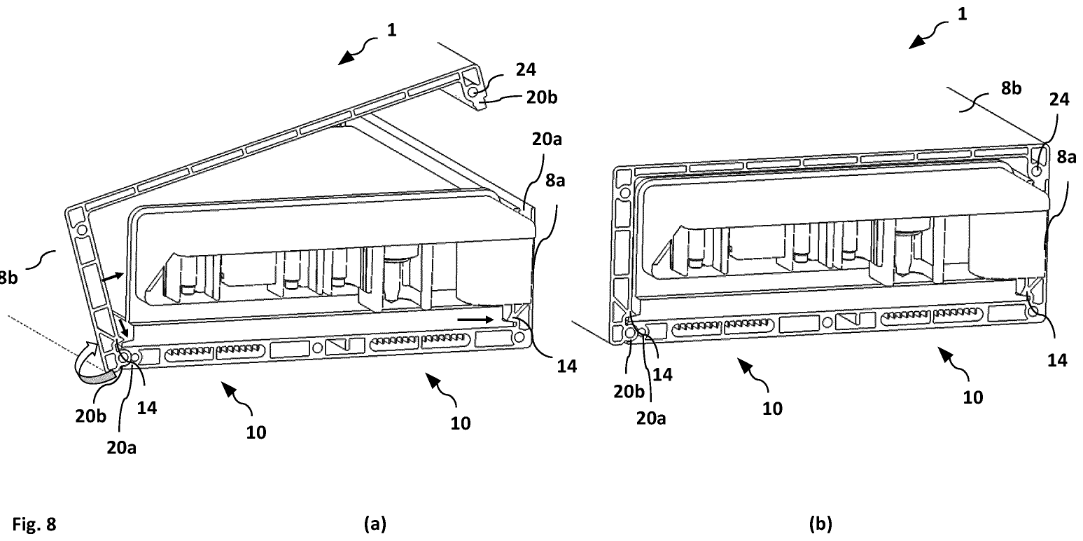

FIG. 8a, b a schematic representation of a battery system according to the invention with open central housing part (a) and closed central housing part (B) in a spatial representation according to a first embodiment,

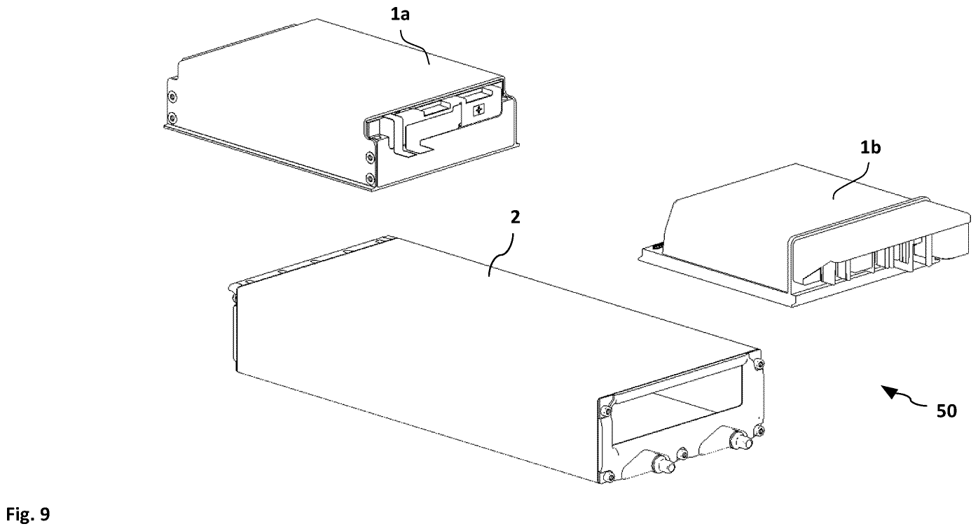

FIG. 9 a schematic representation of the components of a battery system according to the invention in a spatial representation according to a first embodiment,

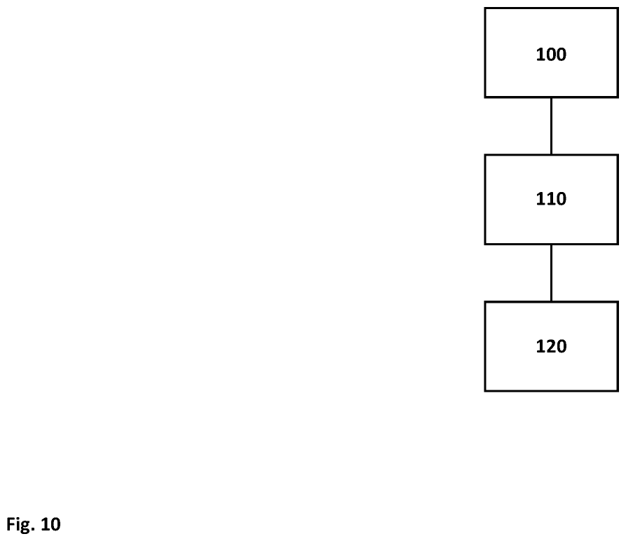

FIG. 10 a schematic representation of the individual stages of the method according to the invention for accommodating a battery module.

FIGS. 1 and 2 show a schematic representation of a housing 2 according to the invention for accommodating a battery module 1 in a spatial view from the front (FIG. 1) and from the rear (FIG. 2) according to a first embodiment.

As can be seen according to FIGS. 1 and 2, the housing 2 for accommodating a battery module 1 has a front housing part 4, a rear housing part 6, and first and second central housing parts 8a, 8b arranged between the front housing part 4 and in the rear housing part 6, wherein the front housing part 4, the rear housing part 6 and the two central housing parts 8a, 8b in the connected state of the housing parts 4, 6, 8a, 8b with one another ensure a complete accommodation for the battery module 1 and wherein within the housing 2 an integrated cooling channel 10 (not visible in FIGS. 1 and 2) for cooling the battery module 1.

As can be seen according to FIG. 1, the front housing part 4 has a first and a second connection 34a, 34b for a flow V and a return R of a cooling channel 10, which is formed by a connection piece 38a, 38b and an inlet piece 36a, 36b.

As can be seen from FIG. 2, the rear housing part 6 has a degassing nozzle 42 for emergency degassing and a closure element 40 for closing a transfer structure (not visible here).

According to FIGS. 1 and 2, the fixing elements 26 formed in the present case in the form of screws for fixing the front and rear housing parts 4, 6 can also be seen.

FIG. 3 shows a schematic representation of the housing 2 according to the invention as shown in FIG. 1 without the second central housing part 8b. As can be seen from FIG. 3, the first central housing part 8a has a side plate 16 and a base plate 16′ arranged essentially perpendicular to the side plate 16.

FIG. 4 shows a schematic representation of a housing 2 according to the invention for accommodating a battery module 1 in a sectional view along the line of intersection X-X from FIG. 1 according to a first embodiment.

According to this sectional view, it can be seen that not only the first central housing part 8a is formed from a side plate 16 and a bottom plate 16′ arranged substantially perpendicular to the side plate 16, but also the second central housing part 8b is formed from a side plate 18 and a top plate 18′ arranged substantially perpendicular thereto. In addition, according to FIG. 4, the cooling channel 10 can be seen to have a forward flow V and a return flow R, both the forward flow V and the return flow R having a first cooling path 10a and a second cooling path 10b, which are separated from one another by a strut 11. Cooling fins 12 are arranged on the upper side of the channel 10 for the purpose of achieving the most effective cooling effect possible.

As can further be seen from FIG. 4, the housing 2 for accommodating a battery module 1 has fixing rails 14 arranged in the side plates 16, 18 of the first central housing part 8a and the second central housing part 8b for fixing the battery module 1, via which the battery module 1 is materially bonded.

Furthermore, according to FIG. 4, the first and second fastening profiles 20a of the first central housing part 8a and the first and second fastening profiles of the second central housing part 28b can be seen, by means of which a positive connection can be made between the first central housing part 8a and the second central housing part 8b. To prevent water from entering, a seal 28 is provided at each of the interfaces between the first central housing part 8a and the second central housing part 8b.

FIG. 5 shows a schematic representation of the front housing part 4 according to the invention in an exploded view according to a first embodiment.

As can be seen according to FIG. 5, the front housing part 4 has a sealing element 28, a reinforcing plate 30, a cover element 32, and the connections of the flow 34a and the return 34b, each of which has a connection pipe 38a, 38b and an inlet pipe 36a and 36b, respectively.

FIG. 6 shows a schematic representation of the rear housing part 6 according to the invention in an exploded view according to a first embodiment.

As can be seen according to FIG. 6, the rear housing part 6 has a sealing element 28″, a reinforcing plate 30′, a cover element 32′, and the closure element 40 for closing a transfer structure of the cover element 32′.

FIG. 7 shows a schematic representation of a partial section of a battery system 50 according to the invention in a spatial representation (a) and an enlarged view (b) according to a first embodiment.

As can be seen from the enlarged section shown in FIG. 7b, the battery module 1 is held form-fittingly within the housing 2 via an undercut 22 of the fixing rail 14. For force-fitting fixing of the front and rear housing parts 4, 6, recesses 24 are provided at the head end within the first and second central housing parts 8a, 8b for the introduction of fixing elements 26, such as screws, bolts or rivets or the like.

FIG. 8 shows a schematic representation of a battery system 50 according to the invention with open (a) second central housing part 8b and closed (b) second central housing part 8b in a spatial representation according to a first embodiment.

As can be seen according to FIG. 8, the battery module 1 is fixed within the fixing rails 14 before the second central housing part 8b is positively inserted into the first fixing profile 20a of the first central housing part 8a via the first fixing profile 20b of the second central housing part 8b, and the second central housing part 8b can be rotatably mounted in such a way that it can be folded down so that the second fixing profile 20b of the second central housing part 8b can be materially bonded to the second fixing profile 20a of the first central housing part 8a.

FIG. 9 shows a schematic representation of the individual components of a battery system 50 according to the invention in a spatial representation according to a first embodiment.

As shown herein, the cell module la and the DC/DC converter 1b of the battery module 1 can be arranged within the housing 2 in a manner advantageous according to the invention.

FIG. 10 shows a schematic representation of the individual steps/stages of the method according to the invention for accommodating a battery module.

Here, the method according to the invention comprises the steps of receiving 100 the battery module 1 via a first central housing part 8a, covering 110 the received battery module 1 by materially bonded the first central housing part 8a to a second central housing part 8b, and closing 120 the housing 2 via connecting the first and second central housing parts 8a, 8b to a front housing part 4 and a rear housing part 6.

By means of the housing 2 according to the invention or the battery system 50 according to the invention and the method for accommodating a battery module 1, it is in particular possible, by means of the arrangement according to the invention of a front housing part 4, a rear housing part 6 and two central housing parts 8a, 8b, to provide a versatilely usable and flexibly adaptable accommodation unit for battery modules 1 which, in particular due to its versatility and adaptability, can at the same time be produced, replaced and maintained quickly and easily. By integrating a cooling channel 10 according to the invention, it is also possible to create a compact and space-saving accommodation unit for accommodating a battery module 1.

### LIST OF REFERENCE SIGNS

1 Battery module

1a Cell module

1b DC/DC converter

2 Housing

4 Front housing part

6 Rear housing part

8a First central housing part

8b Second central housing part

10 Cooling channel

10a First cooling path

10b Second cooling path

11 Strut

12 Cooling fins

14 Fixing splint

16 Side plate of the first central housing section

16′ Base plate of the first central housing section

18 Side plate of the second central housing section

18′ Cover plate of the second central housing section

20a Fastening profile of the first central housing part

20b Fastening profile of the second central housing part

22 Accentuated section

24 Recesses

26 Fixing elements

28 Seals

28′ Sealing element of the front housing section

28″ Sealing element of the rear housing part

30 Strengthening plate of the front housing part

30′ Reinforcing plate of the rear housing part

32 Cover element of the front housing part

32′ Cover element of the rear housing part

34a Connection of the flow

34b Connection of the return

36a Inlet spigot of the supply line

36b Inlet port of the return line

38a Flow connection pipe

38b Return connection piece

40 Closing element

42 Degassing nozzle

50 Battery system

100 Pick up the battery module

110 Covering the picked up battery module

120 Closing the housing

R Return

V Forward

1. A housing for accommodating a battery module, comprising:
a front housing part,
a rear housing part,
a first and a second central housing part arranged between the front housing part and the rear housing part,
wherein the front housing part, the rear housing part and the two central housing parts in the connected state of the housing parts with one another ensure a fully comprehensive accommodation for the battery module,
wherein an integrated cooling channel is arranged within the housing for cooling the battery module.

2. The housing according to claim 1, wherein the housing has an at least partially profiled structure.

3. The housing according to claim 2, wherein the profiled structure is at least partially filled with a shock-absorbing material.

4. The housing according to claim 1, wherein the housing is at least partially formed in the form of extruded profiles.

5. The housing according to claim 1, wherein the houding is formed at least partially in the form of a metal material.

6. The housing according to claim 1, wherein part of the housing [symbol] materially bonded to one another.

7. The housing according to claim 1, wherein the first and second central

[symbol]

8. The housing according to claim 1, wherein the first and/or the second

[symbol]

9. The housing according to claim 1, wherein the first and second central housing parts have a first and second fastening profile for the form-fitting fastening of the

[symbol]

10. The housing according to claim 1, wherein the fastening profiles are formed

[symbol]

11. The housing according to claim 1, whereing at least one of the fastening profiles has an undercut and at least one of the fastening profiles has a corresponding latching hook for reinforcing the form-fitting fastening.

12. The housing according to claim 1, wherein the first and second

[symbol]

13. The housing according to claim 1, wherein the cooling channel

[symbol]

14. The housing according to claim 1, wherein the cooling channel has at least one inlet for introducing cooling water and a return for returning the cooling water.

15. The housing according to claim 1, wherein the cooling channel integrated inside the housing has at least two cooling paths arranged next to one another and separated from one another, the cooling paths being separated from one another by means of a strut.

16. The housing according to claim 1, wherein the cooling channel has cooling fins.

17. The housing according to claim 1, wherein seals are provided for sealing the housing from the outside.

18. The housing according to claim 1, wherein seals are formed in the form of a rubber-based material or a polyurethane-based material or an epoxy-based material.

19. The housing according to claim 1, wherein the front housing part is formed in the form of a multipart component.

20. The housing according to claim 1, wherein the front housing part has at least one sealing element for sealing the housing.

21. The housing according to claim 1, wherein the front housing part has at least one reinforcing plate for reinforcing the rear housing part.

22. The housing according to claim 1, wherein the front housing part has at least one cover element for covering the front housing part.

23. The housing according to claim 1, wherein the front housing part has a first and a second connection for connection to a forward flow and a return flow of a cooling channel.

24. The housing according to claim 1, wherein the connections each have an inlet connection piece for connection to a coolant supply line and each have a connection piece for connection of the inlet connection pieces to a flow and a return of a cooling channel.

25. The housing according to claim 1, wherein the rear housing part is formed in the form of a multipart component.

26. The housing according to claim 1, wherein the rear housing part has at least one sealing element for sealing the housing.

27. The housing according to claim 1, wherein the rear housing part has at least one reinforcing plate for reinforcing the rear housing part.

28. The housing according to claim 1, wherein the rear housing part has at least one covering element for covering the front housing part.

29. The housing according to claim 1, wherein the cover element has a transfer structure for transferring a forward flow of a cooling channel into a return flow.

30. The housing according to claim 1, wherein the rear housing part has at least one degassing connection piece for emergency degassing.

31. The housing according to claim 1, wherein the rear housing part has a closure element for closing the transfer structure of the cover element.

32. A battery system, comprising:
a housing for accommodating a battery module according to claim 1,
a battery module comprising a cell module and a DC/DC converter.

33. The battery system according to claim 32, wherein detection unit is provided for acquiring data for operating a cooling system.

34. A method for accommodating a battery module in a housing, in particular in a housing according to claim 1, comprising:
receiving the battery module via a first central housing part,
covering the housed battery module by materially bonding the first central housing part to a second central housing part,
closing the housing via connecting the first and second central housing parts to a front housing part and a rear housing part.

35. The method of claim 34, wherein the battery module is inserted into a fixing rail during accommodation in the first central housing part for form-fitting fastening of the battery module.

36. The method according to claim 34, wherein the second central housing part is inserted into a corresponding first fastening profile of the first central housing part via a first fastening profile in order to be materially bonded to the first central housing part and is inserted into a corresponding second fastening profile of the first central housing part by a rotation with a second fastening profile.
